(19) United States
(12) Patent Application Publication
(10) Pub. No.: US 2010/0050707 A1
(43) Pub. Date: Mar. 4, 2010

(54) FRAMELESS GLASS DOOR LOCK

(76) Inventor: Shou-Hsing LIAO, Taichung City (TW)

Correspondence Address: LADAS & PARRY, 5670 WILSHIRE BOULEVARD, SUITE 2100, LOS ANGELES, CA, 90036-5679, US

(21) Appl. No.: 12/201,248

(22) Filed: Aug. 29, 2008

(51) Int. Cl. E05B 65/00

(52) U.S. Cl. 70/91

(57) ABSTRACT

A frameless glass door lock includes interior and exterior lock units disposed respectively on inner and outer side surfaces of a glass doorplate. The interior lock unit includes an interior lock housing mounted fixedly on the doorplate, a spindle disposed rotatably in the interior lock housing, a pinion connected fixedly to and coaxial with the spindle, a sliding member movable in the interior lock housing along a direction perpendicular to the spindle, and a rack disposed on the sliding member and engaging the pinion.

### BACKGROUND OF THE INVENTION

1. Field of the Invention

This invention relates to a lock, and more particularly to a frameless glass door lock.

2. Description of the Related Art

Referring to FIGS. 1 and 2, a conventional frameless glass door lock 1 includes a spindle 11 connected to a handle (not shown), a crank member 12 sleeved fixedly on the spindle 11, a sliding member 13 formed with a slide slot 131, and a latch member 14 connected fixedly to the sliding member 13. The crank member 12 is provided with a crankpin 121 movable along the slide slot 131 in the sliding member 13. Rotation of the spindle 11 results in movement of the latch member 14 between a latching position shown in FIG. 2 and a release position shown in FIG. 1.

Since the crank pin 131 rotates about the spindle 11, and since the crank pin 131 and the sliding member 13 move in different directions that are perpendicular to each other, the sliding member 13 cannot move smoothly, thereby resulting in difficulties in locking and unlocking operations of the frameless glass door lock.

### SUMMARY OF THE INVENTION

The object of this invention is to provide a frameless glass door lock that can be operated with ease.

According to this invention, a frameless glass door lock includes interior and exterior lock units disposed respectively on inner and outer side surfaces of a doorplate. The interior lock unit includes an interior lock housing mounted fixedly on the doorplate, a spindle disposed rotatably in the interior lock housing, a pinion connected fixedly to and coaxial with the spindle, a sliding member movable in the interior lock housing along a direction perpendicular to the spindle, and a rack disposed on the sliding member and engaging the pinion.

As such, since rotation of the spindle is converted into movement of the sliding member through only engagement of the pinion and the rack, the spindle can be operated with ease.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a front view of a conventional frameless glass door lock, illustrating a latch member in a release position;

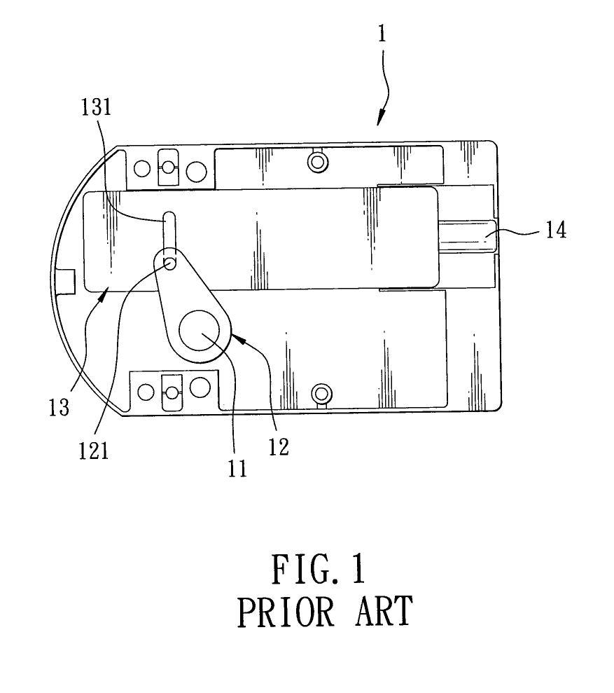

FIG. 2 is a view similar to FIG. 1 but illustrating the latch member in a latching position;

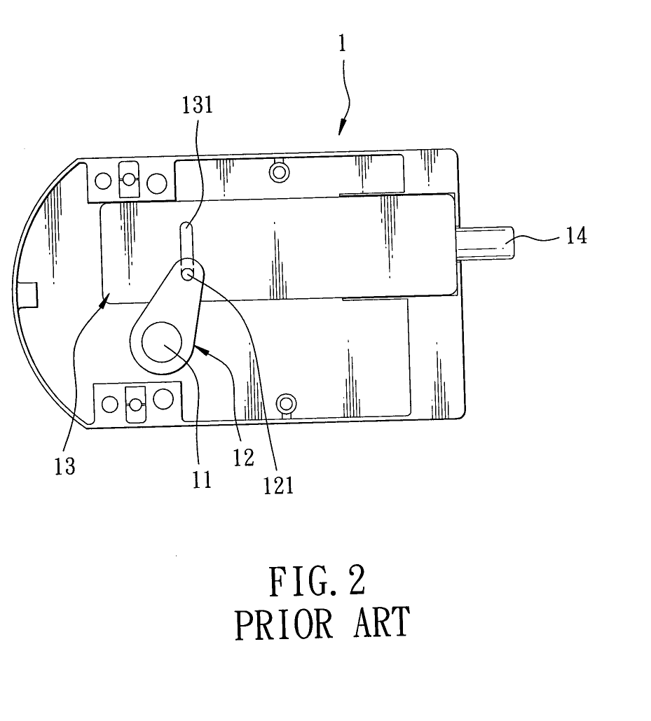

FIG. 3 is an exploded perspective view of the first preferred embodiment of a frameless glass door lock according to this invention;

FIG. 4 is a front view of the first preferred embodiment, illustrating a latch member in a release position;

FIG. 4A is a fragmentary schematic front view of the first preferred embodiment, illustrating positions of first and second indicating portions relative to a window and a through hole when the latch member is disposed in the release position;

FIG. 5 is a view similar to FIG. 4 but illustrating the latch member in a latching position;

FIG. 5A is a view similar to FIG. 4A but illustrating the positions of the first and second indicating portions relative to the window and the through hole when the latch member is disposed in the latching position;

FIG. 6 is a perspective view of the second preferred embodiment of a frameless glass door lock according to this invention, which is mounted on a rotatable glass doorplate; and

FIG. 7 is a schematic top view of the second preferred embodiment, illustrating a slit defined between the rotatable glass doorplate and the frameless glass door lock for receiving a waterproof strip; and

FIG. 8 is a fragmentary schematic front view of the second preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

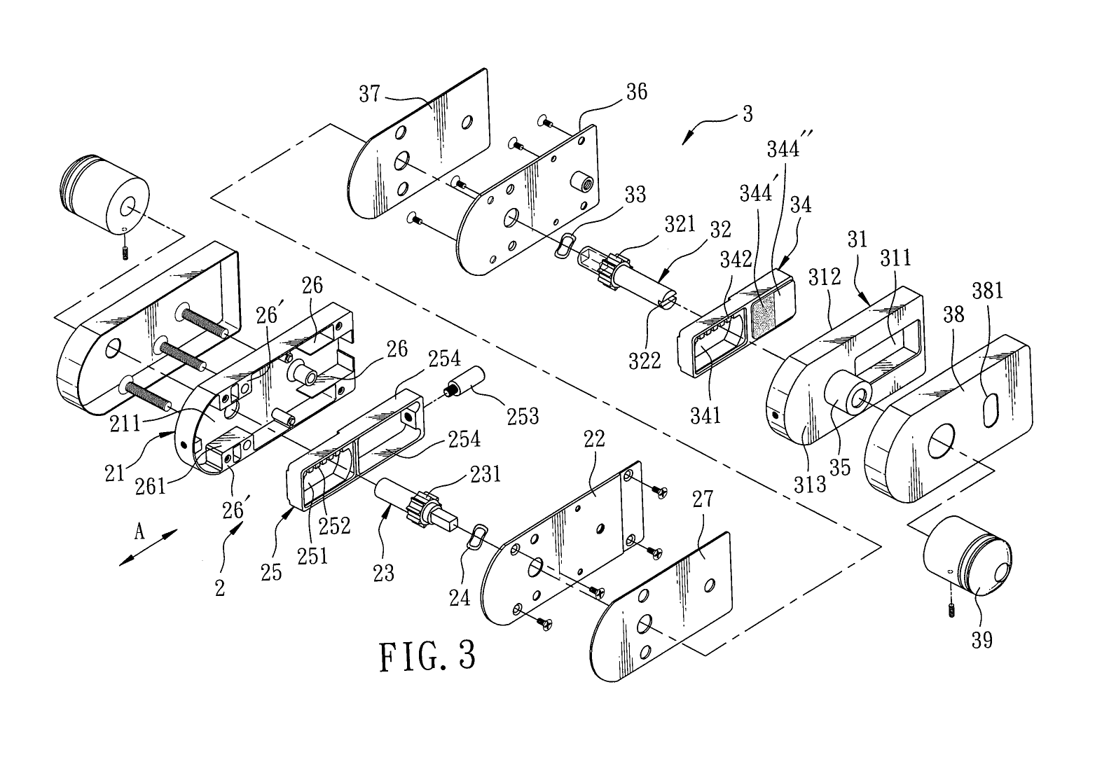

Referring to FIGS. 3, 4, and 5, the first preferred embodiment of a frameless glass door lock includes an interior lock unit 2 and an exterior lock unit 3 that are disposed respectively on inner and outer side surfaces of a rotatable glass doorplate (not shown). As such, the rotatable glass doorplate is disposed between the interior and exterior lock units 2, 3.

The interior lock unit 2 includes an interior lock housing 21, a first housing cover 22, a first spindle 23, a first pinion 231, a first washer 24, a first sliding member 25, a first rack 252, a latch member 253, two first guiding members each consisting of a horizontal guide plate 26 and a guiding block 26′, and a first cushioning plate 27.

The interior lock housing 21 is mounted fixedly on the rotatable glass doorplate and in a room, such as a bathroom or a toilet room, and has an open side facing the rotatable glass doorplate.

The first housing cover 22 is disposed between the interior lock housing 21 and the rotatable glass doorplate for covering the open side of the interior lock housing 21.

The first spindle 23 is disposed rotatably in the interior lock housing 21.

The first pinion 231 is connected fixedly to and coaxial with the first spindle 23.

The washer 24 is a wave washer sleeved on the first spindle 23 and disposed between the first pinion 231 and the first housing cover 22 so as to bias the first pinion 231 to abut against a sidewall 211 of the interior lock housing 21, thereby preventing axial movement of the first spindle 23 within the interior lock housing 21.

The first sliding member 25 has a first slot 251 extending along a longitudinal direction (A) perpendicular to the first spindle 23. The first rack 252 is fixed in a top side of the first slot 252. The first spindle 23 extends through the first slot 251. The first pinion 231 engages the first rack 252. The first sliding member 25 further has horizontal top and bottom walls 254.

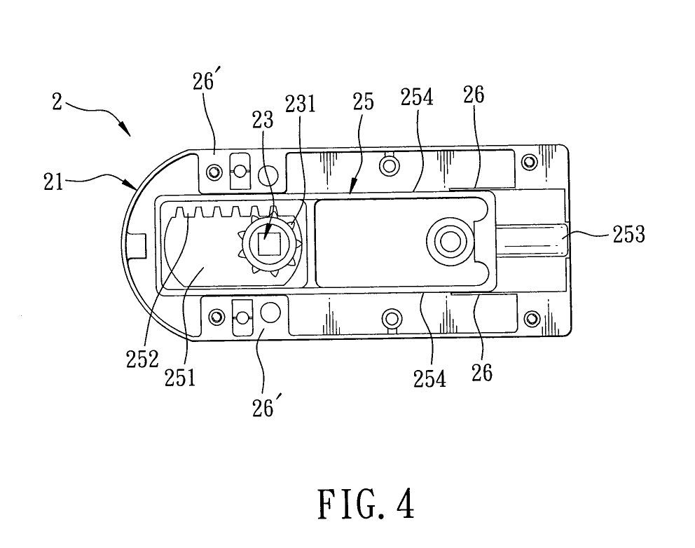

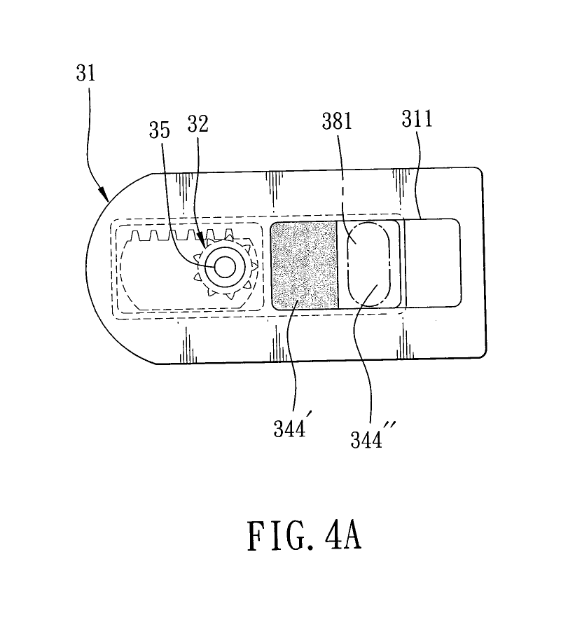

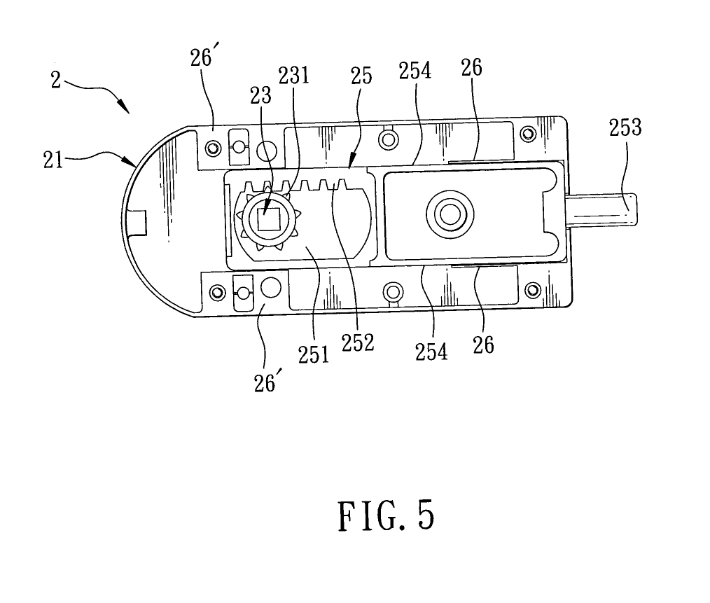

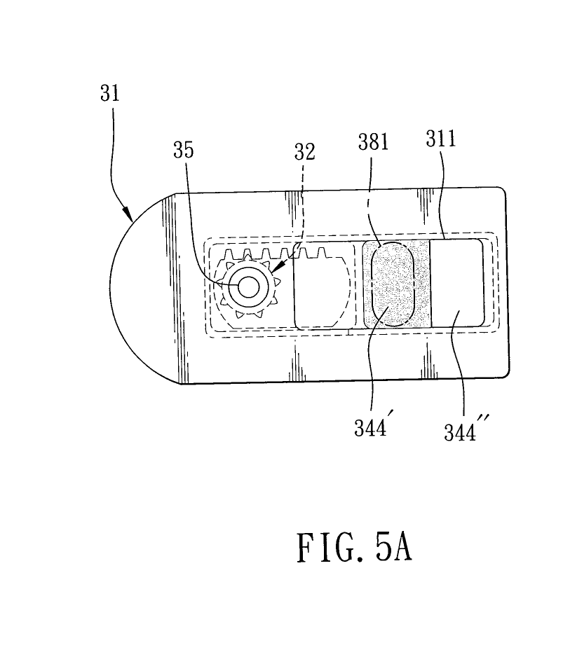

The guide plates 26 and the guiding blocks 26′ of the first guiding members are fixed in the interior lock housing 21. Each of the guiding blocks 26′ has a horizontal contact surface 261. Each of the top and bottom walls 254 of the first sliding member 25 is in slidable contact with the corresponding guide plate 26 and the contact surface 261 of the corresponding guiding block 26′. As such, when the first spindle 23 is rotated, the first sliding member 25 is guided by the guide plates 25 and the guiding blocks 26′ to move relative to the interior lock housing 21 along the longitudinal direction (A) between a release position shown in FIG. 4 and a latching position shown in FIG. 5. In the latching position, the latch member 253 projects from the interior lock housing 21. In the release position, the latch member 253 is retracted into the interior lock housing 21.

The first cushioning plate 27 is clamped between the first housing cover 22 and the rotatable glass doorplate.

The exterior lock unit 3 includes an exterior lock housing 31, a second spindle 32, a second pinion 321, a second washer 33, a second sliding member 34, a second rack 342, a second guiding member (not shown), a handle 35, a second housing cover 36, a second cushioning plate 37, an auxiliary cover 38, and a handle cap 39.

The exterior lock housing 31 is mounted fixedly on the rotatable glass doorplate, and has a window 311 and an open side 312.

The second housing cover 36 is disposed between the exterior lock housing 31 and the rotatable glass doorplate.

The second cushioning plate 37 is clamped between the second housing cover 36 and the rotatable glass doorplate.

The second spindle 32 is disposed rotatably in the exterior lock housing 31, and is connected to and co-rotatable with the first spindle 23.

The second pinion 321 is connected fixedly to and coaxial with the second spindle 32.

The second washer 33 is sleeved on the second spindle 32, and is disposed between the second pinion 321 and the second housing cover 36 for biasing the second pinion 321 to abut against a sidewall 313 of the exterior lock housing 31.

The second sliding member 34 is guided by the second guiding member to move relative to the exterior lock housing 31 along the longitudinal direction (A), and has a second slot 341 extending along the longitudinal direction (A). The second rack 342 is fixed in a top side of the second slot 341. The second spindle 32 extends through the second slot 341. The second pinion 321 engages the second rack 342. As such, rotation of the first spindle 23 relative to the interior lock housing 21 results in movement of the second sliding member 34 relative to the exterior lock housing 31 along the longitudinal direction (A).

The handle 35 is disposed fixedly on the exterior lock housing 31. The second spindle 32 extends through the handle 35, and has an end disposed outwardly of the handle 35 and formed with an open-ended slot 322.

The auxiliary cover 38 is disposed for covering the exterior housing 31.

The handle cap 39 is sleeved removably on the handle 35 for covering the handle 35. When the handle cap 39 is removed, the second spindle 32 can be rotated by operating a tool, such as a screwdriver.

The second sliding member 34 further has a pair of first and second indicating portions 344′, 344″ that are distinguishable visually from each other and that are visible through the window 311 in the exterior lock housing 31 whether the latch member 253 is disposed in the latching position or the release position. In this embodiment, the first indicating portion 344′ is a shaded surface, and the second indicating portion 344″ is a no-shaded surface. Alternatively, the first and second indicating portions 344′, 344″ may be surfaces having different colors. The auxiliary cover 38 is formed with a through hole 381. When the latch member 253 is disposed in the latching position, the first indicating portion 344′ can be seen from the through hole 381, as shown in FIG. 5A, so that use of the room can be realized. When the latch member 253 is disposed in the release position, the second indicating portion 344″ can be seen from the through hole 381, as shown in FIG. 4A, so that vacancy of the room can be realized.

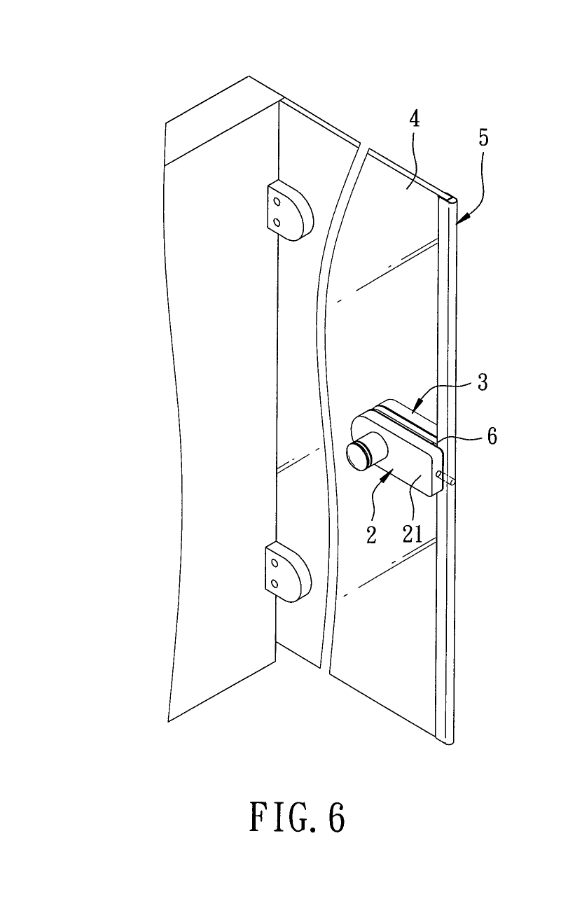

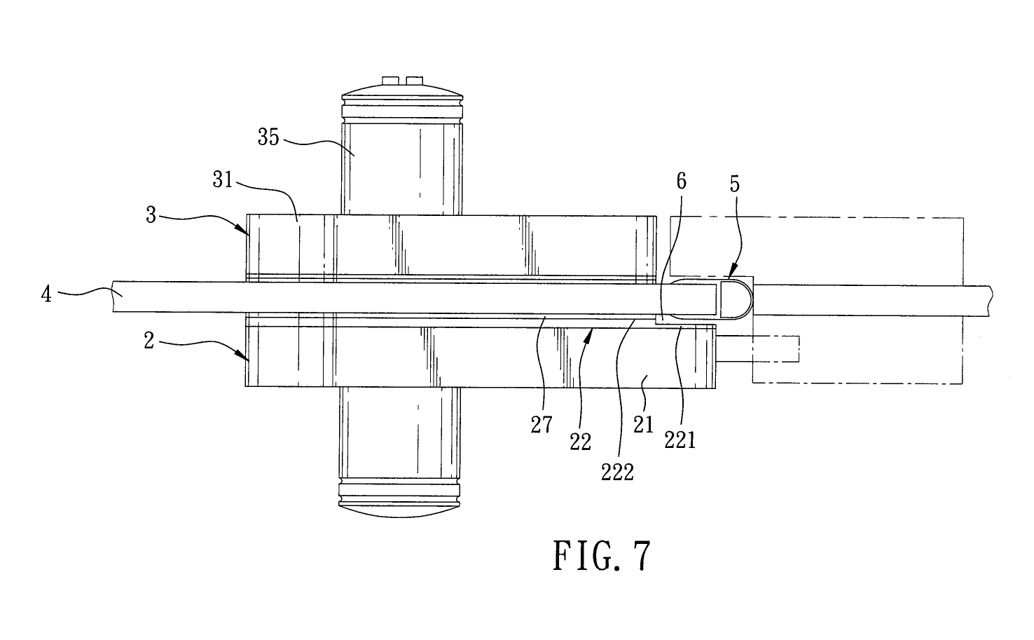

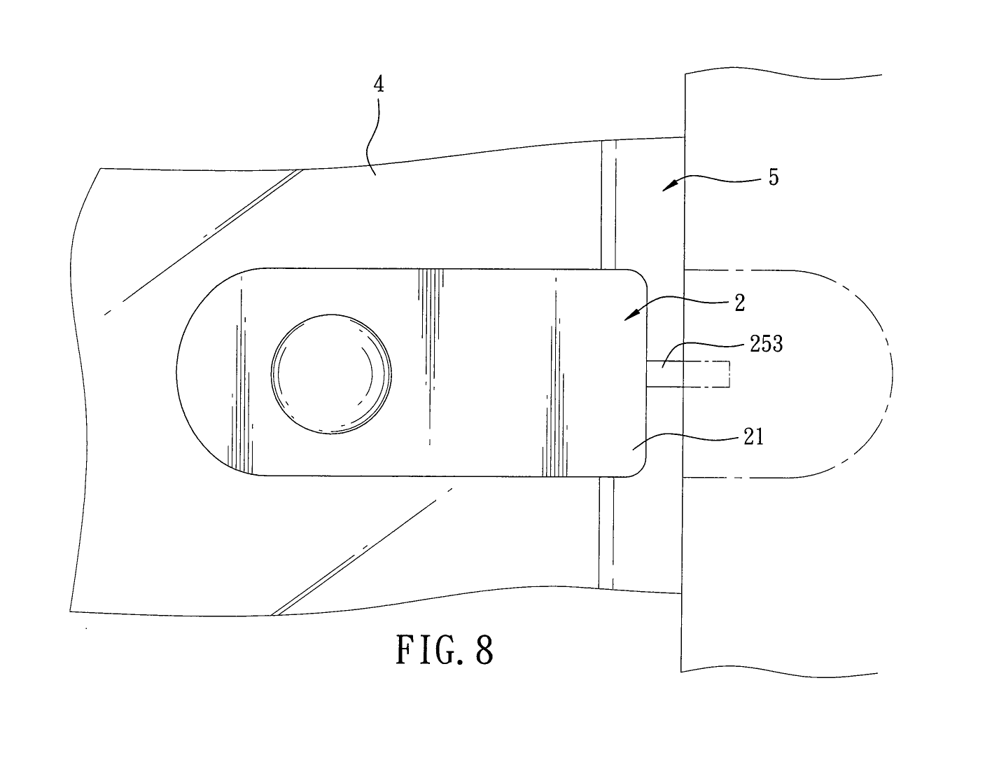

FIGS. 6, 7, and 8 show the second preferred embodiment of a frameless glass door lock according to this invention, which is similar in construction to the first preferred embodiment except that the first cover 22 has a covering portion 221 for covering the open side of the interior lock housing 21, and a projection 222 extending from the covering portion 221 toward the rotatable glass doorplate 4. The first cushioning plate 27 is clamped between the projection 222 and the rotatable glass doorplate 4. An end surface of the first cushioning plate 27 and the first housing cover 22 cooperate with the rotatable glass doorplate 4 to define a waterproof-strip receiving slit 6 thereamong, thereby allowing a waterproof strip 5 to be inserted thereinto. Due to the presence of the waterproof-strip receiving slit 6, it is not necessary to form a notch in the waterproof strip 5 for receiving a portion of the interior lock unit 2.

Since rotation of the first spindle 23 is converted into movement of the first sliding member 25 through only engagement of the first pinion 231 and the first rack 252, the first spindle 23 can be operated with ease.

With this invention thus explained, it is apparent that numerous modifications and variations can be made without departing from the scope and spirit of this invention. It is therefore intended that this invention be limited only as indicated by the appended claims.

I claim:

1. A frameless glass door lock adapted to be mounted to a glass doorplate, the doorplate having opposite inner and outer side surfaces, said frameless glass door lock comprising:
an interior lock unit adapted to be disposed on the inner side surface of the doorplate and including
an interior lock housing adapted to be mounted fixedly on the doorplate,
a first spindle disposed rotatably in said interior lock housing,
a first pinion connected fixedly to and coaxial with said first spindle,
a first sliding member movable in said interior lock housing along a direction perpendicular to said first spindle, and
a first rack disposed on said first sliding member and engaging said first pinion such that rotation of said first spindle relative to said interior lock housing results in movement of said first sliding member relative to said interior lock housing along the direction; and
an exterior lock unit adapted to be disposed on the outer side surface of the doorplate.

2. The frameless glass door lock as claimed in claim 1, wherein said exterior lock unit includes:
an exterior lock housing adapted to be mounted fixedly on the doorplate;
a second spindle disposed rotatably in said exterior lock housing and co-rotatable with said first spindle;
a second pinion connected fixedly to and coaxial with said second spindle;
a second sliding member movable in said exterior lock housing along the direction; and
a rack connected fixedly to said second sliding member and engaging said second pinion such that rotation of said first spindle relative to said interior lock housing results in movement of said second sliding member relative to said exterior lock housing along the direction.

3. The frameless glass door lock as claimed in claim 2, wherein each of said first and second sliding members has horizontal top and bottom walls, and each of said interior and exterior lock housings includes two guiding members fixed therein and in slidable contact with said top and bottom walls of a corresponding one of said first and second sliding members, respectively, such that a corresponding one of said first and second sliding members is guided by said guide members of the corresponding one of said interior and exterior lock housings to move relative to the corresponding one of said interior and exterior lock housings along the direction.

4. The frameless glass door lock as claimed in claim 2, wherein each of said interior and exterior lock housings is formed with a slot extending along the direction, each of said first and second racks being fixed in said slot in a corresponding one of said interior and exterior lock housings, each of said first and second spindles extending through said slot in the corresponding one of said interior and exterior lock housings.

5. The frameless glass door lock as claimed in claim 2, wherein said exterior lock unit further includes a handle disposed fixedly on said exterior lock housing, said second spindle having an end disposed outwardly of said handle and adapted to be rotated by a tool.

6. The frameless glass door lock as claimed in claim 2, wherein:
said exterior lock housing is formed with a window;
said interior lock unit further includes a latch member that is connected fixedly to said first sliding member and that is movable relative to said interior lock housing between a latching position and a release position; and
said second sliding member has first and second indicating portions that are distinguishable visually from each other, said first and second indicating portions being visible through said window in said exterior lock housing whether said latch member is disposed in the latching position or the release position.

7. The frameless glass door lock as claimed in claim 1, wherein said interior lock housing has an open side adapted to face the doorplate, said interior lock unit further including a housing cover adapted to be disposed between said interior lock housing and the doorplate for covering said open side of said interior lock housing, and a washer being sleeved on said first spindle and disposed between said first pinion and said housing cover.

8. The frameless glass door lock as claimed in claim 7, wherein said interior lock unit further includes a cushioning plate adapted to be clamped between said housing cover and the doorplate.

9. The frameless glass door lock as claimed in claim 8, wherein an end surface of said cushioning plate and said housing cover are adapted to cooperate with the doorplate to define a waterproof-strip receiving slit thereamong.

10. The frameless glass door lock as claimed in claim 9, wherein said housing cover has a covering portion for covering said open side of said interior lock housing, and a projection adapted to extend from said covering portion toward the doorplate, said cushioning plate being adapted to be clamped between said projection and the doorplate.
